(19) United States
(12) Patent Application Publication
(10) Pub. No.: US 2017/0036896 A1
(43) Pub. Date: Feb. 9, 2017

(54) WINCH PULLER

(71) Applicant: YEN-WEN CHUNG, Taipei City (TW)

(72) Inventor: YEN-WEN CHUNG, Taipei City (TW)

(21) Appl. No.: 14/817,387

(22) Filed: Aug. 4, 2015

(51) Int. Cl. B66D 3/02; B66D 3/14

(52) U.S. Cl. CPC B66D 3/02; B66D 3/14

(57) ABSTRACT

A winch puller includes a frame having two sideboards spaced from each other. Each of the two sideboards includes first and second ends. The frame further includes a first bracket connected to the first ends of the two sideboards. The frame further includes a second bracket connected to the second ends of the two sideboards. The first bracket includes an intermediate section. A first hook includes a connecting rod mounted to the intermediate section of the first bracket. The first bracket is located between the first hook and the two sideboards. The connecting rod is an integral one-piece member. A ratchet wheel is rotatably mounted between the two sideboards by an axle. A lever is mounted to the axle.

### BACKGROUND OF THE INVENTION

The present invention relates to a manual cable tightening tool and, more particularly, to a winch puller.

A winch puller uses an axle to pull a cable for saving force while an object by hand or tightening a string and is a tool frequently used in factories, vehicle maintenance plants, and tow pounds. Since the human strength is limited, the winch puller can provide a towing function while moving a heavy object (such as a machine or a heavy part). The winch puller can avoid injury to the operator that could have been injured during manual moving of the heavy object and can provide a force saving effect in comparison with manual moving. Thus, the winch puller is widely used by persons in the related art.

Taiwan Patent No. 046257 entitled “Improved Structure for Winch Puller” filed by Applicant discloses a winch puller including a frame and a ratchet wheel/lever unit pivotably mounted in the frame. An end of a cable is fixed to a bottom of the frame. The other end of the cable is fixed to the ratchet wheel/lever unit. The cable is wound around the ratchet wheel and has a section wound around a pulley coupled to a lower hook. Another hook is provided on a top of the frame and engages with a fixture or a loop. After an object to be lifted has been hooked to the lower hook, the lever of the ratchet wheel/lever unit is operated to wind the cable, thereby lifting the object.

However, the hook mounted on the top of the frame is comprised of a plurality of components and, thus, has a plurality of sections. If the object to be lifted is relatively heavy or if the winch puller is subject to a relatively large tension, the components or joints between the components are liable to deform or wear, leading to poor working efficiency and even serious accidents if the components break. Thus, a need exists for a novel winch puller with improved structural strength.

### BRIEF SUMMARY OF THE INVENTION

A winch puller according to the present invention includes a frame having two sideboards spaced from each other. Each of the two sideboards includes first and second ends. The frame further includes a first bracket connected to the first ends of the two sideboards. The frame further includes a second bracket connected to the second ends of the two sideboards. The first bracket includes an intermediate section. A first hook includes a connecting rod mounted to the intermediate section of the first bracket. The first bracket is located between the first hook and the two sideboards. The connecting rod is an integral one-piece member. A ratchet wheel is rotatably mounted between the two sideboards by an axle. A lever is mounted to the axle.

Since the connecting rod of the first hook is an integral one-piece member, hazard risks resulting from damage or disengagement of joints between components in the conventional winch puller due to an excessive tension or frequent use can be avoided while prolonging the service life of the winch puller.

The intermediate section of the first bracket can include a flat board section. The connecting rod of the first hook can be riveted to the flat board section.

Each of the first and second brackets is connected to each of the two sideboards at an intersection having an outer face. At least one rib can be formed on the outer face of each intersection.

The first bracket can further include first and second arms respectively extending from two ends of the intermediate section thereof. The first and second arms of the first bracket are connected to the first ends of the two sideboards. The first and second arms of the first bracket have increasing spacings away from the intermediate section of the first bracket. The second bracket can include an intermediate section having two ends. The second bracket can further include first and second arms respectively extending from the two ends of the second bracket. The first and second arms of the second bracket are connected to the second ends of the two sideboards. The first and second arms of the second bracket have increasing spacings away from the intermediate section of the second bracket.

The winch puller can further include a pulley unit including a housing and a pulley rotatably received in the housing, a cable fixed to the ratchet wheel and wound around the pulley, and a second hook riveted to the housing of the pulley unit.

The present invention will become clearer in light of the following detailed description of illustrative embodiments of this invention described in connection with the drawings.

### DESCRIPTION OF THE DRAWINGS

FIG. 1 is a perspective view of a winch puller according to the present invention.

FIG. 2 is an enlarged perspective view of a portion of the winch puller according to the present invention.

FIG. 3 is a cross sectional view illustrating ribs of the winch puller according to the present invention.

### DETAILED DESCRIPTION OF THE INVENTION

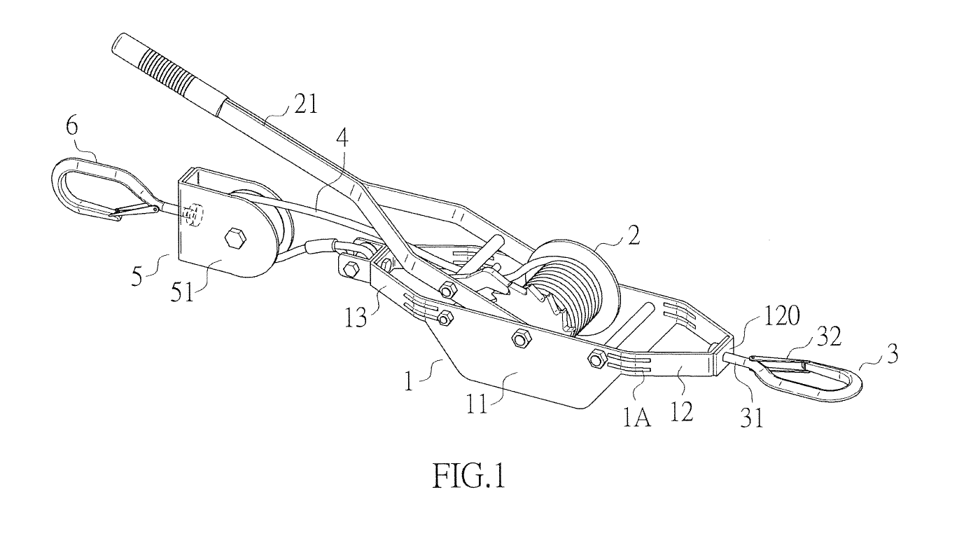

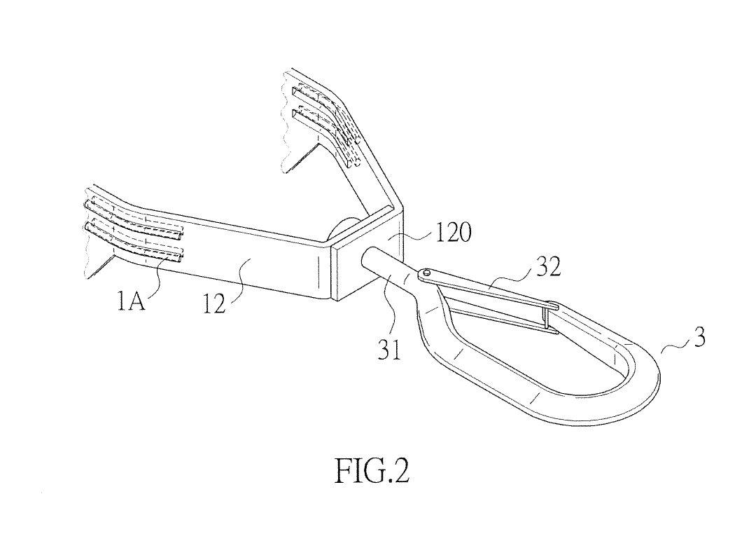

With reference to FIGS. 1 and 2, a winch puller according to the present invention includes a frame 1 and a ratchet wheel 2. The frame 1 includes two sideboards 11 spaced from each other. Each of the two sideboards includes first and second ends. The frame 1 further includes a first bracket 12 connected to the first ends of the two sideboards 11. The frame 1 further includes a second bracket 13 connected to the second ends of the two sideboards 13. In the form shown, each of the first and second brackets 12 and 13 includes an intermediate section and first and second arms respectively extending from two ends of the intermediate section. The first and second arms of the first bracket 12 are connected to the first ends of the two sideboards 11. The first and second arms of the second bracket 13 are connected to the second ends of the two sideboards 11. The first and second arms of the first bracket 12 have increasing spacings away from the intermediate section of the first bracket 12, forming a substantially U-shaped structure. The first and second arms of the second bracket 13 have increasing spacings away from the intermediate section of the second bracket 13, forming a substantially U-shaped structure. Thus, when the frame 1 is subject to a large pulling force, the pulling force can be evenly distributed to the first and second brackets 12 and 13, reducing the chance of deformation of the frame 1.

A first hook 3 includes a connecting rod 31 mounted to the intermediate section of the first bracket 12. The first bracket 12 is located between the first hook 3 and the two sideboards 12 and 13. The connecting rod 31 is an integral one-piece member. An elastic member 32 is pivotably mounted to the first hook 3 and can be pressed to reveal a notch permitting the first hook 3 to engage with a rope or a loop while preventing disengagement of the rope or loop after the elastic member 32 is released. Thus, the winch puller can be fixed. Since the connecting rod 31 of the first hook 3 is an integral one-piece member, hazard risks resulting from damage or disengagement of joints between components in the conventional winch puller due to an excessive tension or frequent use can be avoided while prolonging the service life of the winch puller.

The ratchet wheel 2 is rotatably mounted between the two sideboards 11 by an axle. A lever 21 is mounted to the axle and extends outwards away from the axle.

The winch puller further includes a pulley unit 5 having a housing 51 and a pulley rotatably received in the housing 51. A cable 4 is fixed to the ratchet wheel 2 and is wound around the pulley. A second hook 6 is riveted to the housing 51 of the pulley unit 5. The lever 21 can be operated by an operator to rotate the ratchet wheel 2 for winding the cable 4 around the ratchet wheel 2, thereby moving a heavy object or tightening a rope with less effort. Detailed structures and operation of the ratchet wheel 2 and the lever 21 are conventional and, therefore, not described in detail to avoid redundancy.

The intermediate section of the first bracket 12 includes a flat board section 120. In the form shown, the flat board section 120 is comprised of two superimposed plates welded to each other to form a high-strength connecting structure that is less likely to deform. The connecting rod 31 of the first hook 3 is riveted to the flat board section 120. The second hook 6 is riveted to the housing 51 of the pulley unit 5. Thus, the first and second hooks 3 and 6 are reliably connected to the frame 1 and the housing 51 respectively and can swivel 360°. During use of the cable 4 of the winch puller, the cable 4 is less likely to tangle or twist due to rotation or orientation of the object to be lifted, providing use safety.

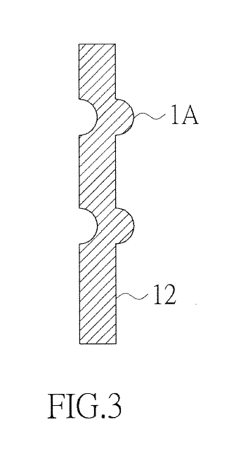

With reference to FIG. 3, each of the first and second brackets 12 and 13 is connected to each of the two sideboards 11 at an intersection. At least one rib 1A is formed on an outer face of each intersection to reinforce the structural strength of the frame 1. Thus, even if the winch puller is subject to a large pulling force, the frame 1 is less likely to deform, avoiding damage to the whole structure.

Although specific embodiments have been illustrated and described, numerous modifications and variations are still possible without departing from the scope of the invention. The scope of the invention is limited by the accompanying claims.

1. A winch puller comprising:
a frame including two sideboards spaced from each other, with each of the two sideboards including first and second ends, with the frame further including a first bracket connected to the first ends of the two sideboards, with the frame further including a second bracket connected to the second ends of the two sideboards, with the first bracket including an intermediate section, with a first hook including a connecting rod mounted to the intermediate section of the first bracket, with the first bracket located between the first hook and the two sideboards, and with the connecting rod being an integral one-piece member; and
a ratchet wheel rotatably mounted between the two sideboards by an axle, with a lever mounted to the axle.

2. The winch puller as claimed in claim 1, wherein the intermediate section of the first bracket includes a flat board section, and wherein the connecting rod of the first hook is riveted to the flat board section.

3. The winch puller as claimed in claim 2, wherein each of the first and second brackets is connected to each of the two sideboards at an intersection having an outer face, and wherein at least one rib is formed on the outer face of each intersection.

4. The winch puller as claimed in claim 3, with the first bracket further including first and second arms respectively extending from two ends of the intermediate section thereof, with the first and second arms of the first bracket connected to the first ends of the two sideboards, with the first and second arms of the first bracket having increasing spacings away from the intermediate section of the first bracket, with the second bracket including an intermediate section having two ends, with the second bracket further including first and second arms respectively extending from the two ends of the second bracket, with the first and second arms of the second bracket connected to the second ends of the two sideboards, and with the first and second arms of the second bracket having increasing spacings away from the intermediate section of the second bracket.

5. The winch puller as claimed in claim 2, further comprising:
a pulley unit including a housing and a pulley rotatably received in the housing;
a cable fixed to the ratchet wheel and wound around the pulley; and
a second hook riveted to the housing of the pulley unit.
